(19) United States
(12) Patent Application Publication
(10) Pub. No.: US 2024/0393440 A1
(43) Pub. Date: Nov. 28, 2024

(54) CONTROL AND CONTROL METHOD

(71) Applicant: Sony Semiconductor Solutions Corporation, Atsugi-shi, Kanagawa (JP)

(72) Inventors: Renato FERRACINI ALVES, Stuttgart (DE); Alexis VANDER BIEST, Stuttgart (DE)

(73) Assignee: Sony Semiconductor Solutions Corporation, Atsugi-shi, Kanagawa (JP)

(21) Appl. No.: 18/689,441

(22) PCT Filed: Sep. 12, 2022
(86) PCT No.: PCT/EP2022/075224

§ 371 Date: Mar. 6, 2024

(30) Foreign Application Priority Data
Sep. 20, 2021 (EP) 21197771.5

(51) Int. Cl. G01S 7/481; G01S 7/4865; G01S 7/487; G01S 17/42; G01S 17/894

(52) U.S. Cl. CPC G01S 7/4817; G01S 7/4865; G01S 7/4876; G01S 17/42; G01S 17/894

(57) ABSTRACT

A control for a line scanning LiDAR device, comprising circuitry configured to: set, for each row of a first set of rows of a light detection pixel array, a first binning of light detection pixels for acquiring a signal contribution of reflected illumination light to obtain distance information; and set, for each row of a second set of rows of the light detection pixel array, a second binning of light detection pixels for acquiring a crosstalk contribution of reflected illumination light to obtain crosstalk information, wherein the first and the second set of rows are either the same or disjunct.

### TECHNICAL FIELD

The present disclosure generally pertains to a control for a line scanning LiDAR device and a control method for a line scanning LiDAR device.

### TECHNICAL BACKGROUND

Generally, time-of-flight (ToF) devices or systems are known. Such ToF devices are typically used for determining a distance to objects in a scene or a depth map of (the objects in) the scene that is illuminated with light.

Direct time-of-flight (“dToF”) devices and indirect time-of-flight (“iToF”) devices are known. In dToF (which may also be known as “LiDAR-Light Detection And Ranging”) devices the distance information is obtained based on a time-of-arrival of light pulses reflected from the scene. In such dToF devices the time between two consecutive light pulses which illuminate the scene is typically divided in time intervals with equal spacing. When a reflected light pulse is detected, an electric signal is generated indicating an event which is associated with one of the time intervals based on the time-of-arrival, thereby histogram data can be generated. A peak (of events) in a histogram represented by such histogram data may indicate the presence of an object in the scene in the distance corresponding to the time-of-arrival.

In LiDAR devices the distance information of the scene is obtained, e.g., in a single measurement (for example, with flooded or full-field illumination of the scene) or by scanning the scene, e.g., with a line of light (e.g., one-dimensional (1D) laser light pattern) along a scanning direction. Scanning of a scene may allow a high resolution, a high detection range independent of object location and a tunable field-of-view.

Scanning LiDAR devices may be divided into two categories. The first category is based on a single sensor element (e.g., a SPAD (“Single Photon Avalanche Diode”) pixel) that works synchronized with a two-dimensional (2D) scanning mirror. In these systems, the illumination light is typically a single light dot. The second category is based on illuminating the scene with 1D light pattern (e.g., laser light) as illumination light, usually a line of light, and detecting the reflected illumination light from the scene in a light detection pixel array (e.g., a line array as well), wherein the scanning mirror movement is restricted to 1D in this case.

However, for example, when a LiDAR device illuminates a region of a scene that is bigger than a field of view of a single sensor element, a light detection pixel of the light detection pixel array—that is imaging a predetermined part of the scene—may receive interfering crosstalk signal from other regions of the scene. It could be caused, for example, by stray light from the receiver side optical system, due to finite optical point spread function (PSF) of the imaging optics and sensor array, or due to other physical processes occurring inside the sensor.

The stray light or scattered light may thus influence the distance measurement of a light detection pixel, especially when, due to a big difference in signal levels in the scene, the crosstalk contribution of reflected illumination light is on the same order of magnitude as the signal contribution expected on that light detection pixel of the light detection pixel array.

Although there exist techniques for line scanning LiDAR devices, it is generally desirable to improve the existing techniques.

### SUMMARY

According to a first aspect the disclosure provides a control for a line scanning LiDAR device, comprising circuitry configured to:
set, for each row of a first set of rows of a light detection pixel array, a first binning of light detection pixels for acquiring a signal contribution of reflected illumination light to obtain distance information; and
set, for each row of a second set of rows of the light detection pixel array, a second binning of light detection pixels for acquiring a crosstalk contribution of reflected illumination light to obtain crosstalk information,
wherein the first and the second set of rows are either the same or disjunct.

According to a second aspect the disclosure provides a control method for a line scanning LiDAR device, comprising:
setting, for each row of a first set of rows of a light detection pixel array, a first binning of light detection pixels for acquiring a signal contribution of reflected illumination light to obtain distance information; and
setting, for each row of a second set of rows of the light detection pixel array, a second binning of light detection pixels for acquiring a crosstalk contribution of reflected illumination light to obtain crosstalk information,
wherein the first and the second set of rows are either the same or disjunct.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates in a block diagram an example of a crosstalk artifact in a time-of-flight measurement;

FIG. 2 schematically illustrates in a block diagram an embodiment of a line scanning LiDAR device in FIG. 2A and in FIG. 2B in a block diagram an embodiment of a data acquisition principle of the line scanning LiDAR device;

FIG. 3 schematically illustrates in a block diagram a first embodiment of a binning of light detection pixels in subsequent data acquisitions;

FIG. 4 schematically illustrates in a block diagram a first embodiment of a binning of light detection pixels in a same data acquisition;

FIG. 5 schematically illustrates in a block diagram a second embodiment of a binning of light detection pixels in subsequent data acquisitions;

FIG. 6 schematically illustrates in a block diagram a second embodiment of a binning of light detection pixels in a same data acquisition; and

FIG. 7 schematically illustrates in a flow diagram an embodiment of a control method for a line scanning LiDAR device.

### DETAILED DESCRIPTION OF EMBODIMENTS

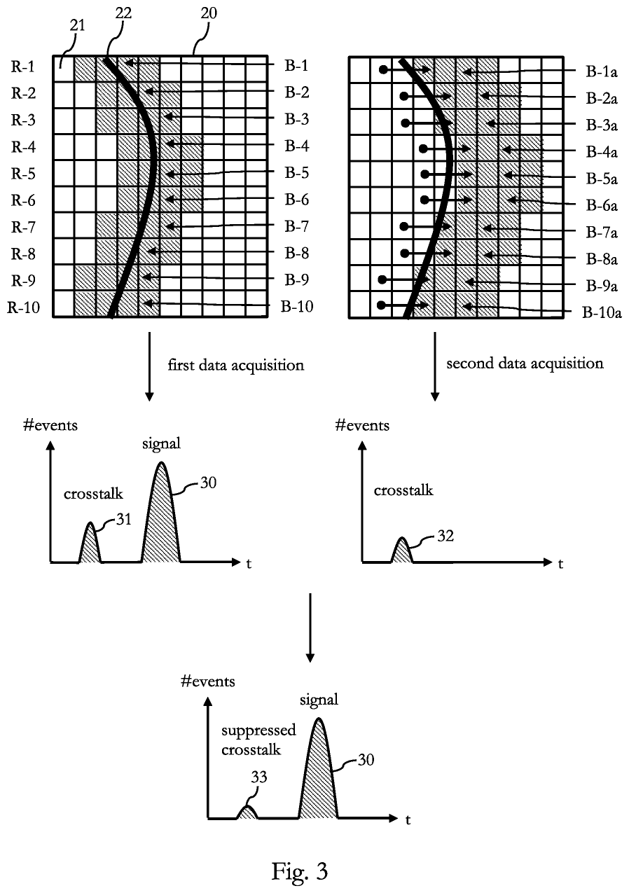

Before a detailed description of the embodiments under reference of FIG. 3 is given, general explanations are made.

As mentioned in the outset, scanning LiDAR (“LiDAR-Light Detection And Ranging”) devices are known, for example, scanning LiDAR devices which are based on illuminating a scene with 1D light pattern (e.g., laser light) as illumination light, usually a line of light, and detecting the reflected illumination light from the scene in a light detection pixel array (e.g., a line array as well), wherein the scanning mirror movement is restricted to 1D in this case.

However, in such line scanning LiDAR devices, a light detection pixel of the light detection pixel array—that is imaging a predetermined part of the scene—may receive interfering crosstalk signal from other regions of the scene which may be caused by stray light in an optical lens portion (e.g., a lens stack) in an imaging unit of the scanning LiDAR device, thereby a crosstalk contribution may overlap with a signal contribution.

The crosstalk may thus influence the distance measurement of a light detection pixel, especially when, due to a big difference in signal levels in the scene, the scattering contribution of reflected illumination light is on the same order of magnitude as the signal contribution expected on that light detection pixel of the light detection pixel array.

For example, when illumination light, reflected by a high reflective object (e.g. reflective traffic signs) with dark background, is imaged onto the light detection pixel array, artifacts in the time-of-flight measurement may be observed due to stray light of the reflected illumination light, e.g., crosstalk contributions in the histogram data from light detection pixels in a direction perpendicular to the scanning direction and in the scanning direction are observed. The crosstalk contributions may be, for example, up to five orders of magnitude in intensity between highly reflective and dark areas in the scene.

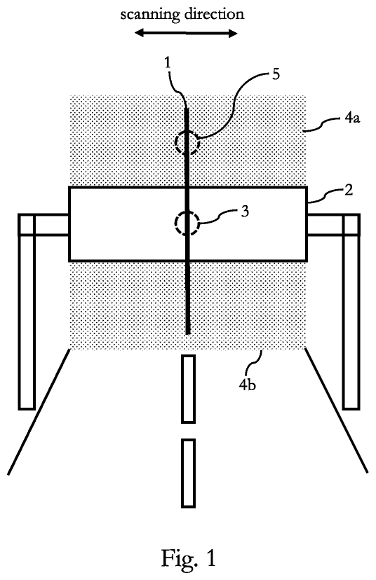

For enhancing the general understanding of the present disclosure, an example of a crosstalk artifact in a time-of-flight measurement is discussed under reference of FIG. 1 in the following, which schematically illustrates the example in a block diagram.

A line scanning LiDAR device (not shown) illuminates a scene with a line of light 1 in which a reflective object 2, here a traffic sign, is present. A scanning direction of the line scanning LiDAR device is perpendicular to the line of light 1.

In the time-of-flight measurement a signal contribution is observed which indicates an object point 3 on the reflective object 2.

However, the reflective object 2 causes stray light of the line of light 1 in a direction perpendicular to the scanning direction and in the scanning direction.

Hence, due to the scattering at the reflective object 2 and stray light inside an optical lens portion of an imaging unit of the line scanning LiDAR device, for example, due to multiple reflections in a lens stack of the optical lens portion, crosstalk contributions in the histogram data from light detection pixels in a direction perpendicular to the scanning direction and in the scanning direction are typically observed. These may indicate, for example, an alleged object point 5 in a scene region 4a above the reflective object 2. Other alleged object points may be observed in a scene region 4b below the reflective object 2.

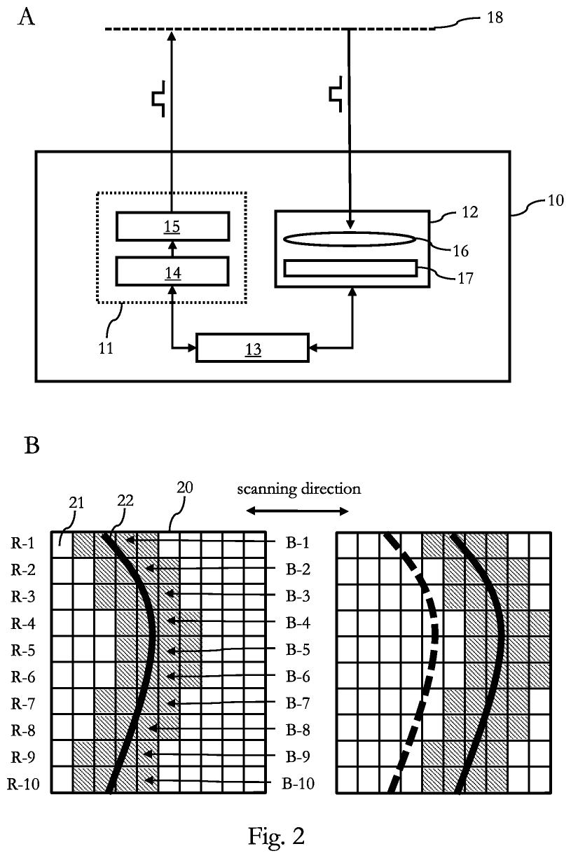

For further enhancing the general understanding of the present disclosure, an embodiment of a line scanning LiDAR device 10 is discussed under reference of FIG. 2A in the following, which also applies to other embodiments of the present disclosure. FIG. 2A schematically illustrates the line scanning LiDAR device 10 in a block diagram.

The line scanning LiDAR device 10 includes an illumination unit 11, an imaging unit 12 and a control 13.

The control 13 basically controls the overall operation of the line scanning LiDAR device 10, for example, light emission timing, data acquisition, synchronization between the illumination unit 11 and the imaging unit 12, etc., as generally known.

The illumination unit 11 includes a light source 14 and a scanning unit 15.

The imaging unit 12 includes an optical lens portion 16 and a light detection sensor 17.

The light source 14 includes a laser diode configured to emit a line of light (e.g., 1D illumination light pattern) to a scene 18.

The scanning unit 15 includes a scanning mirror for scanning the scene 18 with the line of light emitted by the light source 14 along a scanning direction.

The scene 18 includes one or more objects (not shown) which reflect at least a part of the illumination light.

The optical lens portion 16 is configured to image the reflected illumination light onto the light detection sensor 17.

A data acquisition principle of the line scanning LiDAR device 10 is discussed under reference of FIG. 2B, which schematically illustrates in a block diagram the data acquisition principle of the line scanning LiDAR device 10.

The light detection sensor 17 of FIG. 2A includes a light detection pixel array 20 which includes a plurality of light detection pixels 21 arranged in rows R1 to R-10 and columns. Here, for illustration purposes only, the light detection pixel array 20 has ten rows R-1 to R-10, however, the present disclosure is not limited to any particular number of rows and columns of the light detection pixel array 20 (e.g. the number of rows and columns may be adapted to a specific need).

As mentioned above, the scanning unit 15 scans the scene 18 with the line of light emitted by the light source 14 along the scanning direction. For example, by rotating a scanning mirror from a first scanning position to a second scanning position such that the line of light illuminates a different part of the scene 18.

Each scanning position is associated with a predetermined subset of the plurality of light detection pixels 21 which will be discussed in the following.

On the left of FIG. 2B, a data acquisition principle for a first scanning position is schematically illustrated. The control 13 sets, for each row of the rows R-1 to R-10, a binning of light detection pixels for acquiring a signal contribution of reflected illumination light to obtain distance information (of the scene 18). The binning of light detection pixels in each row of the rows R-1 to R-10 includes or is based on a respective macroblock B-1 to B-10, wherein the respective macroblock B-1 to B-10 is at a predetermined position with a predetermined width. The macroblocks B-1 to B-10 may thus also be referred to as predetermined macroblocks.

The predetermined position and the predetermined width in each row of the rows R-1 to R-10 of the respective macroblock B-1 to B-10 is set in accordance with an expected reflected line of light 22. The expected reflected line of light 22 corresponds to a typical imaging position of the line of light, which illuminates the scene 18, when reflected in the scene 18. Thereby, the reflected illumination light (reflected line of light here) to be measured is likely imaged onto the light detection pixels of the respective macroblock B-1 to B-10 such that a signal contribution of reflected illumination light is acquired to obtain distance information.

The predetermined positions and the predetermined widths may be obtained, for example, experimentally or based on simulations or based on theoretical calculations.

Each macroblock B-1 to B-10 includes adjacent light detection pixels which are binned, wherein binning corresponds to the accumulation of events in a single histogram represented by histogram data based on electric signals of all of the adjacent light detection pixels of the macroblock. Hence, due to binning, only a single histogram is generated and not one histogram for each light detection pixel of the respective macroblock B-1 to B-10.

Generally, the expected reflected line of light 22 may have a spatial line width which covers more than one light detection pixel such that, for acquiring the whole signal contribution, more than one light detection pixel is binned.

However, due to the binning of more than one light detection pixel, a crosstalk contribution is typically acquired as well (in some embodiments).

Then, for a second scanning position, the predetermined positions of the macroblocks B-1 to B-10 are shifted along the scanning direction as illustrated on the right of FIG. 2B. The dashed line corresponds to the expected reflected line of light 22 as shown on the left of FIG. 2B and the solid line corresponds to an expected reflected line of light for the second scanning position.

Returning to the general explanations, it has been recognized that, in order to compensate the crosstalk effect in scanning LiDAR devices, the crosstalk contribution should be measured in the imaging plane.

It has further been recognized that, for measuring the crosstalk contribution, macroblocks shifted with respect to the predetermined positions or macroblocks having a width larger than the predetermined macroblocks may be utilized. Thereby, a crosstalk contribution may be probed which may be used to improve the distance information. Note that the macroblocks shift could be done in the same frame of in a subsequent frame, assuming the scene does not change significantly in the time interval between the two frames.

Hence, some embodiments pertain to a control for a line scanning LiDAR device, including circuitry configured to:
set, for each row of a first set of rows of a light detection pixel array, a first binning of light detection pixels for acquiring a signal contribution of reflected illumination light to obtain distance information; and
set, for each row of a second set of rows of the light detection pixel array, a second binning of light detection pixels for acquiring a crosstalk contribution of reflected illumination light to obtain crosstalk information,
wherein the first and the second set of rows are either the same or disjunct.

Thus, some embodiments pertain to a line scanning LiDAR device, comprising:
an illumination unit configured to illuminate a scene with a line of light;
an imaging unit including a light detection pixel array including a plurality of light detection pixels arranged in rows and columns, wherein each of the plurality of light detection pixels is configured to detect illumination light reflected from the scene and to generate an electric signal in response to the detection of the reflected illumination light; and
a control including circuitry configured to:
   set, for each row of a first set of rows of the light detection pixel array, a first binning of light detection pixels for acquiring a signal contribution of reflected illumination light to obtain distance information; and
   set, for each row of a second set of rows of the light detection pixel array, a second binning of light detection pixels for acquiring a crosstalk contribution of reflected illumination light to obtain crosstalk information,
   wherein the first and the second set of rows are either the same or disjunct.

The illumination unit may include a light source, such as a laser diode, a laser diode array, a light emitting diode, a light emitting diode array or the like. The illumination unit may be configured to scan the scene with the line of light along a scanning direction. The illumination unit may include optical parts, a scanning mirror, etc, for scanning the scene with the line of light along the scanning direction.

The plurality of light detection pixels may include single photon avalanche diode pixels or avalanche photodiode pixels or the like.

The line of light may be spatially modulated in intensity, for example, the line of light may a dotted line of light.

The circuitry may be based on or may include or may be implemented as integrated circuitry logic or may be implemented by one or more CPUs (central processing unit), one or more application processors, one or more graphical processing units (GPU), one or more microcontrollers, one or more FPGAs (field programmable gate array), an ASIC (application specific integrated circuit) or the like configured to achieve the functions as described herein. The functionality may be implemented by software executed by a processor such as an application processor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include a communication interface configured to communicate and exchange data with a computer or processor (e.g. an application processor or the like) over a network (e.g. the internet) via a wired or a wireless connection such as WiFi®, Bluetooth® or a mobile telecommunications system which may be based on UMTS, LTE or the like (and implements corresponding communication protocols).

The circuitry may include data storage capabilities to store data such as memory which may be based on semiconductor storage technology (e.g. RAM, EPROM, etc.) or magnetic storage technology (e.g, a hard disk drive) or the like.

The circuitry may include a data bus (interface) (e.g, a Camera Serial Interface (CSI) in accordance with MIPI (Mobile Industry Processor Interface) specifications (e.g. MIPII CSI-2 or the like) or the like). The circuitry may include a data bus interface for transmitting (and receiving) data over a data bus.

The setting of a first and a second binning of light detection pixels may be, for example, achieved by software-based accumulation of events in a single histogram represented by histogram data based on electric signals of all the binned light detection pixels. The setting of a first and a second binning of light detection pixels may also be, for example, achieved by hardware-based binning in the light detection array, as generally known.

The first binning of light detection pixels is set, for each row of a first set of rows of the light detection pixel array, for acquiring a signal contribution of reflected illumination light to obtain distance information, as discussed, for example, under reference of FIG. 2.

The second binning of light detection pixels is set, for each row of a second set of rows of the light detection pixel array, for acquiring a crosstalk contribution of reflected illumination light to obtain crosstalk information, wherein the first and the second set of rows are either the same or disjunct.

The embodiments for acquiring the crosstalk contribution in a line scanning LiDAR device may be, basically, divided in two categories. The first category is based on using a light detection pixel mismatch with respect to the expected reflected line of light in order to probe the crosstalk contribution (mismatch with respect to the predetermined positions of the binned light detection pixels in the light detection pixel array). The second category is based on using a different number of binned light detection pixels than with the predetermined widths in order to probe a different amount of the crosstalk contribution to thereby acquire the crosstalk contribution in a differential form.

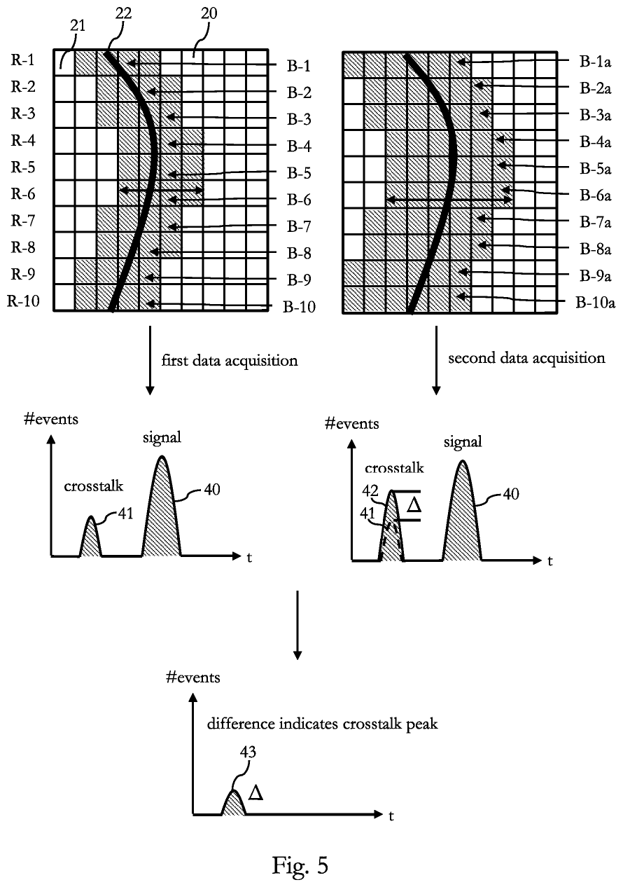

In some embodiments, when the first and the second set of rows are the same, the first and the second binning are set in subsequent data acquisitions. Such embodiments will be discussed in more detail under reference of FIGS. 3 and 5.

In some embodiments, the first binning includes a first macroblock of light detection pixels and the second binning includes a second macroblock of light detection pixels.

A macroblock of light detection pixels includes adjacent light detection pixels which are binned.

In some embodiments, the second macroblock is shifted with respect to the first macroblock. Such embodiments will be discussed in more detail under reference of FIG. 3.

The amount of shifting—along the respective row—may be, for example, based on the spatial width of the expected reflected line of light or may be based on analyzing the spatial width of the measured reflected line of light.

In some embodiments, the second macroblock is larger than the first macroblock. Such embodiments will be discussed in more detail under reference of FIG. 5.

The width of the second macroblock—in the respective row—may be, for example, based on the spatial width of the expected reflected line of light or may be based on analyzing the spatial width of the measured reflected line of light.

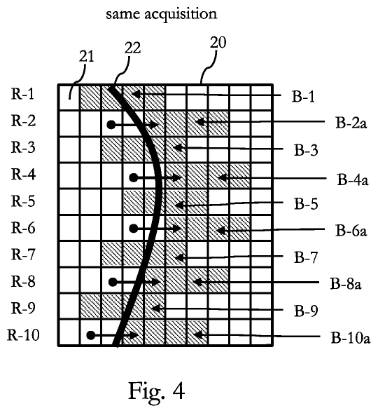

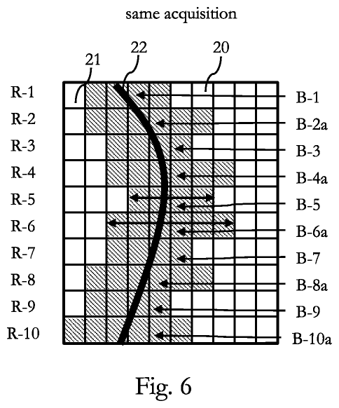

In some embodiments, when the first and the second set of rows are disjunct, the first and the second binning are set in a same data acquisition. Such embodiments will be discussed in more detail under reference of FIGS. 4 and 6.

In some embodiments, the first binning includes a first macroblock of light detection pixels and the second binning includes a second macroblock of light detection pixels.

In some embodiments, the second macroblock is shifted with respect to a predetermined position. Such embodiments will be discussed in more detail under reference of FIG. 4.

The amount of shifting—along the respective row—may be, for example, based on the spatial width of the expected reflected line of light.

In some embodiments, the second macroblock is larger than a predetermined macroblock of light detection pixels. Such embodiments will be discussed in more detail under reference of FIG. 6.

The width of the second macroblock—in the respective row—may be, for example, based on the spatial width of the expected reflected line of light.

In some embodiments, a single data acquisition or a same data acquisition includes reading all rows of the light detection pixel array (hence, in such embodiments, subsequent data acquisitions include reading all rows of the light detection pixel array once in a first data acquisition and then again in second data acquisition). In some embodiments, a single data acquisition or a same data acquisition includes reading a predetermined subset of rows of the light detection pixel array (for example, the predetermined subset of rows includes at least the first set of rows).

Typically, crosstalk compensation in LiDAR devices may be based on signal processing including, for example, calibration and some assumptions on a crosstalk kernel, however, this may be prone to errors in some cases due to suboptimal compensation or overcompensation, as generally known. Thus, embodiments as described herein may be a practical way for directly measuring the crosstalk contribution which may allow for a more robust crosstalk compensation algorithm.

In some embodiments, the circuitry is further configured to:
generate, based on the first binning of light detection pixels, first histogram data;
generate, based on the second binning of light detection pixels, second histogram data; and
generate, based on the first and the second histogram data, third histogram data to improve the distance information.

Some embodiments pertain to a control method for a line scanning LiDAR device, including:
setting, for each row of a first set of rows of a light detection pixel array, a first binning of light detection pixels for acquiring a signal contribution of reflected illumination light to obtain distance information; and
setting, for each row of a second set of rows of the light detection pixel array, a second binning of light detection pixels for acquiring a crosstalk contribution of reflected illumination light to obtain crosstalk information,
wherein the first and the second set of rows are either the same or disjunct.

The control method may be performed by the control as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 3, there is schematically illustrated in a block diagram a first embodiment of a binning of light detection pixels in subsequent data acquisitions, which will be discussed in the following.

The embodiment is based on the line scanning LiDAR device 10 discussed under reference of FIG. 2.

In the upper left of FIG. 3, a first binning of light detection pixels of the light detection pixel array 20 in a first data acquisition is illustrated.

The control 13 sets the first binning of light detection pixels for acquiring a signal contribution 30 of reflected illumination light to obtain distance information for each row of a first set of rows R-1 to R-10 of the light detection pixel array 20.

The first binning includes, in each row of the first set of rows R-1 to R-10, a first macroblock B-1 to B-10 of light detection pixels such that adjacent light detection pixels are binned. Hence, the first set of rows includes rows R-1 to R-10.

For the sake of illustration only, each macroblock B-1 to B-10 includes four light detection pixels, however, the present disclosure is not limited to any specific number of light detection pixels in each macroblock B-1 to B-10. Moreover, each macroblock B-1 to B-10 may include a different number of light detection pixels, for example, macroblock B-1 may include four light detection pixels, macroblock B-2 may include three light detection pixels, etc.

Here, in the first data acquisition, each of the first macroblocks B-1 to B-10 is set at a predetermined position with a predetermined width within the respective row R-1 to R-10, wherein the predetermined position and the predetermined width are set in accordance with an expected reflected line of light 22.

In the following it is assumed that the expected reflected line of light 22 corresponds to a measured reflected line of light.

Then, as discussed under reference of FIG. 2, typically, due to the binning of more than one light detection pixel in each macroblock B-1 to B-10, a crosstalk contribution 31 is acquired in addition to the signal contribution 30.

This is illustrated in the middle left of FIG. 3, where a histogram corresponding to the first data acquisition is schematically illustrated in a graph. The histogram, represented by first histogram data generated by the control 13 based on the first binning, includes the signal contribution 30 and the crosstalk contribution 31.

The signal contribution 30 indicates, based on the time-of-arrival, distance information to an object (not shown) which is present in the scene 18 and which is illuminated with a line of light.

However, as the histogram also includes a crosstalk contribution 31 at some earlier time-of-arrival, an alleged object may be detected as well, which is actually not present in the scene.

Generally, the crosstalk contribution 31 may overlap spatially with the signal contribution 30 and may overlap in time (time-of-arrival) with the signal contribution 30. Moreover, the crosstalk contribution 31 may be observed before or after the signal contribution 30.

Here, for the sake of illustration only, the crosstalk contribution 31 is observed before the signal contribution 30, however, as mentioned, the crosstalk contribution 31 may overlap in time with the signal contribution 30.

In the upper right of FIG. 3, a second binning of light detection pixels of the light detection pixel array 20 in a second data acquisition is illustrated, wherein the second data acquisition is subsequent to the first data acquisition.

Hence, in order to improve the distance information, the control 13 sets the second binning of light detection pixels for acquiring a crosstalk contribution 32 of reflected illumination light to obtain crosstalk information for each row of a first set of rows R-1 to R-10 of the light detection pixel array 20.

The second binning includes, in each row of the first set of rows R-1 to R-10, a second macroblock B-1a to B-10a of light detection pixels such that adjacent light detection pixels are binned. Hence, the second set of rows includes rows R-1 to R-10 and, thus, the first set of rows and the second set of rows are the same.

The second macroblocks B-1a to B-10a are shifted with respect to the first macroblocks B-1 to B-10, as illustrated by the arrow in each row R-1 to R-10 in the upper right of FIG. 3.

Hence, by shifting the second macroblocks B-1a to B-10a, the signal contribution 31 may not be acquired, however, the crosstalk contribution 32 is acquired, since crosstalk contributions may occur in the scanning direction and in the row direction (perpendicular to the scanning direction), e.g., due to lens stray light, as discussed above.

This is illustrated in the middle right of FIG. 3, where a histogram corresponding to the second data acquisition is schematically illustrated in a graph. The histogram, represented by second histogram data generated by the control 13 based on the second binning, includes the crosstalk contribution 32.

The crosstalk contribution 32 is indicative for the crosstalk contribution 31 in the first data acquisition.

Hence, in order to improve the distance information, the second histogram data are subtracted from the first histogram data, for example, to generate third histogram data. The third histogram data represent a histogram as illustrated in the lower middle of FIG. 3 which includes a suppressed crosstalk contribution 33 and the signal contribution 30.

Therefore, in such embodiments, a crosstalk contribution 32 in each row of the first set of rows is measured in subsequent data acquisitions.

FIG. 4 schematically illustrates in a block diagram a first embodiment of a binning of light detection pixels in a same data acquisition, which will be discussed in the following.

In contrast to FIG. 3, where a crosstalk contribution 32 is measured in a subsequent data acquisition, the first and the second binning are set in the same acquisition in the embodiment of FIG. 4.

The control 13 sets the first binning of light detection pixels for acquiring a signal contribution of reflected illumination light to obtain distance information for each row of a first set of rows (R-1, R-3, R-5, R-7 and R-9) of the light detection pixel array 20.

The first binning includes, in each row of the first set of rows (R-1, R-3, R-5, R-7 and R-9), a first macroblock (B-1, B-3, B-5, B-7 and B-9) of light detection pixels such that adjacent light detection pixels are binned. Hence, the first set of rows includes rows (R-1, R-3, R-5, R-7 and R-9).

The control 13 sets the second binning of light detection pixels for acquiring a crosstalk contribution of reflected illumination light to obtain crosstalk information for each row of a second set of rows (R-2, R-4, R-6, R-8 and R-10) of the light detection pixel array 20.

The second binning includes, in each row of the second set of rows (R-2, R-4, R-6, R-8 and R-10), a second macroblock (B-2a, B-4a, B-6a, B-8a and B-10a) of light detection pixels such that adjacent light detection pixels are binned. Hence, the second set of rows includes rows (R-2, R-4, R-6, R-8 and R-10) and, thus, the first and the second set of rows are disjunct.

The second macroblocks (B-2a, B-4a, B-6a, B-8a and B-10a) are shifted with respect to predetermined positions, as illustrated by the arrows in the second set of rows (R-2, R-4, R-6, R-8 and R-10).

Thereby, signal contributions and crosstalk contributions may be acquired in a single data acquisition, however, signal contributions are acquired in rows of the first set of rows (R-1, R-3, R-5, R-7 and R-9) and crosstalk contributions are acquired in rows of the second set of rows (R-2, R-4, R-6, R-8 and R-10).

Hence, the signal contributions in rows of the second set of rows (R-2, R-4, R-6, R-8 and R-10) may be obtained based on the signal contributions in rows of the first set of rows (R-1, R-3, R-5, R-7 and R-9). For instance, the signal contribution may be interpolated based on signal contributions of adjacent rows. For instance, the signal contribution may be an average signal contribution based on signal contributions of adjacent rows.

Thus, the crosstalk contributions in rows of the first set of rows (R-1, R-3, R-5, R-7 and R-9) may be obtained based on the crosstalk contributions in rows of the second set of rows (R-2, R-4, R-6, R-8 and R-10). For instance, the crosstalk contribution may be interpolated based on crosstalk contributions of adjacent rows. For instance, the crosstalk contribution may be an average crosstalk contribution based on crosstalk contributions of adjacent rows.

As mentioned above, in some embodiments (for example, in this embodiment) the signal contribution and the crosstalk contribution are acquired in a same data acquisition. The same data acquisition may include reading the rows of the light detection pixel array 20 line-by-line or reading the first set of rows (R-1, R-3, R-5, R-7 and R-9) and then the second set of rows (R-2, R-4, R-6, R-8 and R-10). However, the data acquisition may not be sequential, for example, the light detection pixel array 20 may read all rows at once and thus read the first set of rows (R-1, R-3, R-5, R-7 and R-9) for the signal contribution and the second set of rows (R-2, R-4, R-6, R-8 and R-10) for the crosstalk contribution at the same time.

FIG. 5 schematically illustrates in a block diagram a second embodiment of a binning of light detection pixels in subsequent data acquisitions, which will be discussed in the following.

The embodiment is based on the line scanning LiDAR device 10 discussed under reference of FIG. 2.

In the upper left of FIG. 5, a first binning of light detection pixels of the light detection pixel array 20 in a first data acquisition is illustrated.

The control 13 sets the first binning of light detection pixels for acquiring a signal contribution 40 of reflected illumination light to obtain distance information for each row of a first set of rows R-1 to R-10 of the light detection pixel array 20.

The first binning includes, in each row of the first set of rows R-1 to R-10, a first macroblock B-1 to B-10 of light detection pixels such that adjacent light detection pixels are binned. Hence, the first set of rows includes rows R-1 to R-10.

Here, in the first data acquisition, each of the first macroblocks B-1 to B-10 is set at a predetermined position with a predetermined width within the respective row R-1 to R-10, wherein the predetermined position and the predetermined width are set in accordance with an expected reflected line of light 22.

In the following it is assumed that the expected reflected line of light 22 corresponds to a measured reflected line of light.

Then, as discussed under reference of FIG. 2, typically, due to the binning of more than one light detection pixel in each macroblock B-1 to B-10, a crosstalk contribution 41 is acquired in addition to the signal contribution 40.

This is illustrated in the middle left of FIG. 5, where a histogram corresponding to the first data acquisition is schematically illustrated in a graph. The histogram, represented by first histogram data generated by the control 13 based on the first binning, includes the signal contribution 40 and the crosstalk contribution 41.

The signal contribution 40 indicates, based on the time-of-arrival, distance information to an object (not shown) which is present in the scene 18 and which is illuminated with a line of light.

However, as the histogram also includes a crosstalk contribution 41 at some earlier time-of-arrival, an alleged object may be detected as well, which is actually not present in the scene.

In the upper right of FIG. 5, a second binning of light detection pixels of the light detection pixel array 20 in a second data acquisition is illustrated, wherein the second data acquisition is subsequent to the first data acquisition.

Hence, in order to improve the distance information, the control 13 sets the second binning of light detection pixels for acquiring a crosstalk contribution 42 of reflected illumination light to obtain crosstalk information for each row of a first set of rows R-1 to R-10 of the light detection pixel array 20.

The second binning includes, in each row of the first set of rows R-1 to R-10, a second macroblock B-1a to B-10a of light detection pixels such that adjacent light detection pixels are binned. Hence, the second set of rows includes rows R-1 to R-10 and, thus, the first set of rows and the second set of rows are the same.

The second macroblocks B-1a to B-10a are larger than the first macroblocks B-1 to B-10, as illustrated by the arrow in the upper left and right of FIG. 5. In other words, the second macroblocks B-1a to B-10a are larger than predetermined macroblocks B-1 to B-10.

Hence, by enlarging the second macroblocks B-1a to B-10a, the signal contribution 41 is acquired as well, however, the crosstalk contribution 42 is acquired in a differential form, since crosstalk contributions may occur in the scanning direction and in the row direction (perpendicular to the scanning direction) and, thus, more scattered light is accumulated in the crosstalk contribution 42 while the signal contribution 40 remains the same.

This is illustrated in the middle right of FIG. 5, where a histogram corresponding to the second data acquisition is schematically illustrated in a graph. The histogram, represented by second histogram data generated by the control 13 based on the second binning, includes the signal contribution 40 and the crosstalk contribution 42 in a differential form.

The crosstalk contribution 42 is indicative for the crosstalk contribution 41 in the first data acquisition, since only the difference in the histograms is due to crosstalk, thereby an indication of a region of the crosstalk contribution 41 is obtained.

Hence, in order to improve the distance information, in a first processing, the first histogram data are subtracted from the second histogram data to generate differential histogram data. The differential histogram data represent a histogram as illustrated in the lower middle of FIG. 5 which includes a differential crosstalk contribution 43 corresponding to the difference between the crosstalk contribution 42 and the crosstalk contribution 41.

Then, in a second processing, the differential histogram data are, for example, scaled based on a difference in the number of light detection pixels in the first macroblocks B-1 to B-10 and in the second macroblocks B-1a to B-10a and the number of light detection pixels in the macroblocks B-1 to B-10.

Then, in a third processing, the scaled differential histogram data are, for example, subtracted from the first histogram data to generate third histogram data. Hence, based on the first and the second histogram data, third histogram data is generated to improve the distance information.

Therefore, in such embodiments, a crosstalk contribution 42 in each row of the first set of rows is measured in a differential form in subsequent data acquisitions.

FIG. 6 schematically illustrates in a block diagram a second embodiment of a binning of light detection pixels in a same data acquisition, which will be discussed in the following.

In contrast to FIG. 5, where a crosstalk contribution 42 is measured in a differential form in a subsequent data acquisition, in the present embodiment, the first and the second binning are set in the same acquisition in the embodiment of FIG. 6.

The control 13 sets the first binning of light detection pixels for acquiring a signal contribution of reflected illumination light to obtain distance information for each row of a first set of rows (R-1, R-3, R-5, R-7 and R-9) of the light detection pixel array 20.

The first binning includes, in each row of the first set of rows (R-1, R-3, R-5, R-7 and R-9), a first macroblock (B-1, B-3, B-5, B-7 and B-9) of light detection pixels such that adjacent light detection pixels are binned. Hence, the first set of rows includes rows (R-1, R-3, R-5, R-7 and R-9).

The control 13 sets the second binning of light detection pixels for acquiring a crosstalk contribution of reflected illumination light to obtain crosstalk information for each row of a second set of rows (R-2, R-4, R-6, R-8 and R-10) of the light detection pixel array 20.

The second binning includes, in each row of the second set of rows (R-2, R-4, R-6, R-8 and R-10), a second macroblock (B-2a, B-4a, B-6a, B-8a and B-10a) of light detection pixels such that adjacent light detection pixels are binned. Hence, the second set of rows includes rows (R-2, R-4, R-6, R-8 and R-10) and, thus, the first and the second set of rows are disjunct.

The second macroblocks (B-2a, B-4a, B-6a, B-8a and B-10a) are larger than predetermined macroblocks (B-1, B-3, B-5, B-7 and B-9) of light detection pixels having predetermined widths, as illustrated, for example, by the arrow in row R-6 which is longer than the arrow in row R-5.

Thereby, signal contributions and crosstalk contributions may be acquired in a single data acquisition, however, crosstalk contributions in a differential form are acquired in rows of the second set of rows (R-2, R-4, R-6, R-8 and R-10).

Thus, the crosstalk contributions in a differential form in rows of the first set of rows (R-1, R-3, R-5, R-7 and R-9) may be obtained based on the crosstalk contributions in rows of the second set of rows (R-2, R-4, R-6, R-8 and R-10). For instance, the crosstalk contribution may be interpolated based on crosstalk contributions of adjacent rows. For instance, the crosstalk contribution may be an average crosstalk contribution based on crosstalk contributions of adjacent rows.

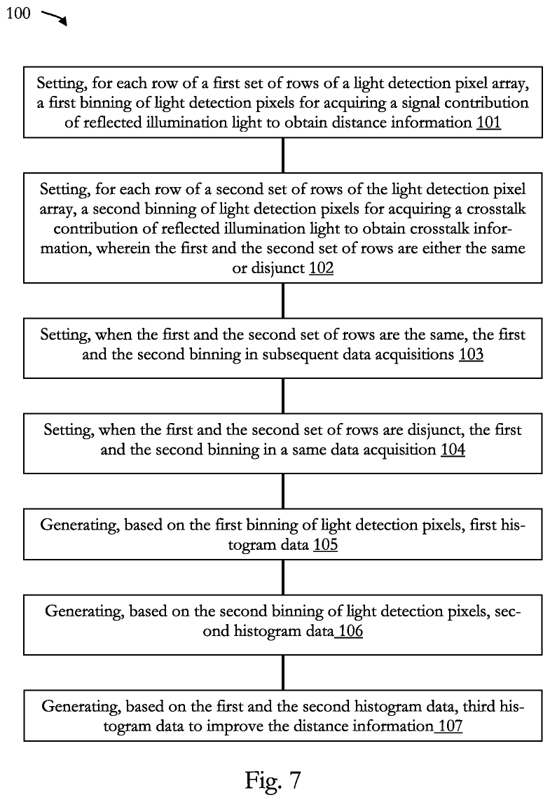

FIG. 7 schematically illustrates in a flow diagram an embodiment of a control method 100 for a line scanning LiDAR device, which will be discussed in the following.

The control method 100 may be performed by a control for a line scanning LiDAR device as described herein such as the control 13 of the line scanning LiDAR device 10 of FIG. 2.

At 101, for each row of a first set of rows of a light detection pixel array, a first binning of light detection pixels is set for acquiring a signal contribution of reflected illumination light to obtain distance information, as discussed herein.

At 102, for each row of a second set of rows of the light detection pixel array, a second binning of light detection pixels is set for acquiring a crosstalk contribution of reflected illumination light to obtain crosstalk information, wherein the first and the second set of rows are either the same or disjunct, as discussed herein.

At 103, when the first and the second set of rows are the same, the first and the second binning in subsequent data acquisitions is set, as discussed herein.

At 104, when the first and the second set of rows are disjunct, the first and the second binning in a same data acquisition is set, as discussed herein.

At 105, based on the first binning of light detection pixels, first histogram data is generated, as discussed herein.

At 106, based on the second binning of light detection pixels, second histogram data is generated, as discussed herein.

At 107, based on the first and the second histogram data, third histogram data to improve the distance information is generated, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A control for a line scanning LiDAR device, including circuitry configured to:
set, for each row of a first set of rows of a light detection pixel array, a first binning of light detection pixels for acquiring a signal contribution of reflected illumination light to obtain distance information; and
set, for each row of a second set of rows of the light detection pixel array, a second binning of light detection pixels for acquiring a crosstalk contribution of reflected illumination light to obtain crosstalk information, wherein the first and the second set of rows are either the same or disjunct.

(2) The control of (1), wherein, when the first and the second set of rows are the same, the first and the second binning are set in subsequent data acquisitions.

(3) The control of (2), wherein the first binning includes a first macroblock of light detection pixels and the second binning includes a second macroblock of light detection pixels.

(4) The control of (3), wherein the second macroblock is shifted with respect to the first macroblock.

(5) The control of (3) or (4), wherein the second macroblock is larger than the first macroblock.

(6) The control of anyone of (1) to (5), wherein, when the first and the second set of rows are disjunct, the first and the second binning are set in a same data acquisition.

(7) The control of (6), wherein the first binning includes a first macroblock of light detection pixels and the second binning includes a second macroblock of light detection pixels.

(8) The control of (7), wherein the second macroblock is shifted with respect to a predetermined position.

(9) The control of (7) or (8), wherein the second macroblock is larger than a predetermined macroblock of light detection pixels.

(10) The control of anyone of (1) to (9), wherein the circuitry is further configured to:
generate, based on the first binning of light detection pixels, first histogram data;
generate, based on the second binning of light detection pixels, second histogram data; and
generate, based on the first and the second histogram data, third histogram data to improve the distance information.

(11) A control method for a line scanning LiDAR device, including:
setting, for each row of a first set of rows of a light detection pixel array, a first binning of light detection pixels for acquiring a signal contribution of reflected illumination light to obtain distance information; and setting, for each row of a second set of rows of the light detection pixel array, a second binning of light detection pixels for acquiring a crosstalk contribution of reflected illumination light to obtain crosstalk information, wherein the first and the second set of rows are either the same or disjunct.

(12) The control method of (11), further including:
setting, when the first and the second set of rows are the same, the first and the second binning in subsequent data acquisitions.

(13) The control method of (12), wherein the first binning includes a first macroblock of light detection pixels and the second binning includes a second macroblock of light detection pixels.

(14) The control method of (13), wherein the second macroblock is shifted with respect to the first macroblock.

(15) The control method of (13) and (14), wherein the second macroblock is larger than the first macroblock.

(16) The control method of anyone of (11) to (15), further including:
setting, when the first and the second set of rows are disjunct, the first and the second binning in a same data acquisition.

(17) The control method of (16), wherein the first binning includes a first macroblock of light detection pixels and the second binning includes a second macroblock of light detection pixels.

(18) The control method of (17), wherein the second macroblock is shifted with respect to a predetermined position.

(19) The control method of (17) or (18), wherein the second macroblock is larger than a predetermined macroblock of light detection pixels.

(20) The control method of anyone of (11) to (19), further including:
generating, based on the first binning of light detection pixels, first histogram data;
generating, based on the second binning of light detection pixels, second histogram data; and
generating, based on the first and the second histogram data, third histogram data to improve the distance information.

(21) A computer program comprising program code causing a computer to perform the control method according to anyone of (11) to (20), when being carried out on a computer.

(22) A non-transitory computer-readable recording medium that stores therein a computer program product, which, when executed by a processor, causes the control method according to anyone of (11) to (20) to be performed.

(23) A line scanning LiDAR device, including:
an illumination unit configured to illuminate a scene with a line of light;
an imaging unit including a light detection pixel array including a plurality of light detection pixels arranged in rows and columns, wherein each of the plurality of light detection pixels is configured to detect illumination light reflected from the scene and to generate an electric signal in response to the detection of the reflected illumination light; and
a control including circuitry configured to:
   set, for each row of a first set of rows of the light detection pixel array, a first binning of light detection pixels for acquiring a signal contribution of reflected illumination light to obtain distance information; and
   set, for each row of a second set of rows of the light detection pixel array, a second binning of light detection pixels for acquiring a crosstalk contribution of reflected illumination light to obtain crosstalk information,
   wherein the first and the second set of rows are either the same or disjunct.

(24) The line scanning LiDAR device of (23), wherein the line of light is spatially modulated in intensity.

(25) The line scanning LiDAR device of (24), wherein the line of light is a dotted line of light.

(26) The line scanning LiDAR device of anyone of (23) to (25), wherein the illumination unit is further configured to scan the scene with the line of light along a scanning direction.

(27) The line scanning LiDAR device of anyone of (23) to (26), wherein the plurality of light detection pixels are single photon avalanche diode pixels.

1. A control for a line scanning LiDAR device, comprising circuitry configured to:
set, for each row of a first set of rows of a light detection pixel array, a first binning of light detection pixels for acquiring a signal contribution of reflected illumination light to obtain distance information; and
set, for each row of a second set of rows of the light detection pixel array, a second binning of light detection pixels for acquiring a crosstalk contribution of reflected illumination light to obtain crosstalk information,
wherein the first and the second set of rows are either the same or disjunct.

2. The control according to claim 1, wherein, when the first and the second set of rows are the same, the first and the second binning are set in subsequent data acquisitions.

3. The control according to claim 2, wherein the first binning includes a first macroblock of light detection pixels and the second binning includes a second macroblock of light detection pixels.

4. The control according to claim 3, wherein the second macroblock is shifted with respect to the first macroblock.

5. The control according to claim 3, wherein the second macroblock is larger than the first macroblock.

6. The control according to claim 1, wherein, when the first and the second set of rows are disjunct, the first and the second binning are set in a same data acquisition.

7. The control according to claim 6, wherein the first binning includes a first macroblock of light detection pixels and the second binning includes a second macroblock of light detection pixels.

8. The control according to claim 7, wherein the second macroblock is shifted with respect to a predetermined position.

9. The control according to claim 7, wherein the second macroblock is larger than a predetermined macroblock of light detection pixels.

10. The control according to claim 1, wherein the circuitry is further configured to:
generate, based on the first binning of light detection pixels, first histogram data;
generate, based on the second binning of light detection pixels, second histogram data; and
generate, based on the first and the second histogram data, third histogram data to improve the distance information.

11. A control method for a line scanning LiDAR device, comprising:
setting, for each row of a first set of rows of a light detection pixel array, a first binning of light detection pixels for acquiring a signal contribution of reflected illumination light to obtain distance information; and
setting, for each row of a second set of rows of the light detection pixel array, a second binning of light detection pixels for acquiring a crosstalk contribution of reflected illumination light to obtain crosstalk information,
wherein the first and the second set of rows are either the same or disjunct.

12. The control method according to claim 11, further comprising:
setting, when the first and the second set of rows are the same, the first and the second binning in subsequent data acquisitions.

13. The control method according to claim 12, wherein the first binning includes a first macroblock of light detection pixels and the second binning includes a second macroblock of light detection pixels.

14. The control method according to claim 13, wherein the second macroblock is shifted with respect to the first macroblock.

15. The control method according to claim 13, wherein the second macroblock is larger than the first macroblock.

16. The control method according to claim 11, further comprising:
setting, when the first and the second set of rows are disjunct, the first and the second binning in a same data acquisition.

17. The control method according to claim 16, wherein the first binning includes a first macroblock of light detection pixels and the second binning includes a second macroblock of light detection pixels.

18. The control method according to claim 17, wherein the second macroblock is shifted with respect to a predetermined position.

19. The control method according to claim 17, wherein the second macroblock is larger than a predetermined macroblock of light detection pixels.

20. The control method according to claim 11, further comprising:
generating, based on the first binning of light detection pixels, first histogram data;
generating, based on the second binning of light detection pixels, second histogram data; and
generating, based on the first and the second histogram data, third histogram data to improve the distance information.
